(19) United States
(12) Patent Application Publication
(10) Pub. No.: US 2020/0382304 A1
(43) Pub. Date: Dec. 3, 2020

(54) USER IDENTITY VERIFICATION METHOD FOR SECURE TRANSACTION ENVIRONMENT

(71) Applicant: WANIN INTERNATIONAL CO., LTD., TAICHUNG CITY (TW)

(72) Inventor: CHENG-HAO HSIAO, TAICHUNG CITY (TW)

(73) Assignee: WANIN INTERNATIONAL CO., LTD., TAICHUNG CITY (TW)

(21) Appl. No.: 16/538,096

(22) Filed: Aug. 12, 2019

(30) Foreign Application Priority Data
May 30, 2019 (TW) 108118780

(51) Int. Cl. H04L 9/32; G06F 16/182; H04L 9/30; H04L 9/14; G06Q 20/38

(52) U.S. Cl. CPC H04L 9/3228; G06F 16/1824; H04L 2209/38; H04L 9/14; G06Q 20/382; H04L 9/30

(57) ABSTRACT

A user identity verification method for secure transaction environment includes the steps of: a user device submitting an attempt having a user communication code to a portal system; the portal system generating and transmitting a one-time verification information; the user device receiving the one-time verification information and generating a user public key and a user private key; the user device submitting a registration information and an input information responding to the one-time verification information; and the portal system verifying the input information and then the portal system generating and transmitting a new user registration information having the registration information to a distributed ledger system when the input information satisfies the one-time verification information, and then, the distributed ledger system registering the registration information in a smart contract of the distributed ledger system to become a legitimate user and allowing the legitimate user to access the distributed ledger system.

### BACKGROUND OF THE INVENTION

### 1. Field of the Invention

The present invention relates to the method of identity verification and login and more particularly, to a user identity verification method for secure transaction environment.

### 2. Description of the Related Art

As the communication network develops, the blockchain is seen as an environment that provides secure transactions. Because the nodes linked to each other in the blockchain store the complete smart contract, when any node wants to trade, the node will broadcast the transaction to other nodes for the consensus calculation of all nodes. After that, the node that first completed the calculation records the verified transaction on the blockchain. A smart contract recorded on a blockchain cannot be modified and is considered a secure trading environment.

Blockchain transactions are conducted through a public key and a private key. The public key is used to verify the transaction data. The private key is used to encrypt the transaction data. The encrypted transaction data will be broadcast to each node, and each node uses the public key of the transaction data to perform consensus calculation to verify the authenticity of the transaction data. Consensus calculus is not able to get the private key in reverse.

At present, most users choose an online wallet (platform or system) to generate the user's public key and private key on the online wallet, and the user uses the public key and the private key to conduct transactions. The online wallet transaction process is encrypted and decrypted by the online wallet's blockchain server instead of the user's hardware device, so the user's public and private key security cannot be ensured.

In addition, there may be some camouflage entry systems in the online wallet, which are used to spoof the user's public and private keys.

Both the public key and the private key are strings of multiple digits. Because the strings are composed of many numbers, it is difficult for the user to remember the strings and is not convenient to use them.

### SUMMARY OF THE INVENTION

The present invention has been accomplished under the circumstances in view. It is the main object of the present invention to provide a user identity verification method for secure transaction environment, which provides a convenient and secure access to the secure transaction environment through the familiar user communication code, and can avoid the online transaction environment to obtain the user's private key, ensuring the security of the transaction environment and the identity verification.

To achieve this and other objects of the present invention, a user identity verification method for secure transaction environment comprises the steps of: a user device submitting an attempt comprising a user communication code to a portal system; the portal system generating and transmitting a one-time verification information corresponding to the user communication code; the user device receiving the one-time verification information and generating a user public key and a user private key; the user device submitting a registration information comprising the user communication code and the user public key and an input information responding to the one-time verification information; and the portal system verifying the input information and then the portal system generating and transmitting a new user registration information comprising the registration information to a distributed ledger system when the input information satisfies the one-time verification information, and then, the distributed ledger system registering the registration information in a smart contract of the distributed ledger system to become a legitimate user and allowing the legitimate user to access the distributed ledger system.

Thus, the user public key and the user private key corresponding to the user communication code in the user identity verification method for secure transaction environment of the present invention are generated in the user device, so the user public key and the user private key will not be obtained in the portal system, distributed ledger system or network connection environment. Furthermore, after the registration is completed, the user only needs to use the familiar user communication code to verify the identity, and the user does not need to use the self-designed password, so the convenience of verifying the identity is better.

The detailed environment, device, system, use or operation mode of the user identity verification method for secure transaction environment provided by the present invention will be described in the detailed description of the subsequent embodiments. However, it should be understood by those of ordinary skill in the art that the detailed description and specific embodiments of the invention are intended to be illustrative of the invention but not to limit the scope of the patent application of the present invention.

### BRIEF DESCRIPTION OF THE DRAWINGS

FIG. 1 is a schematic diagram of a secure transaction environment of the present invention.

FIG. 2 is a registration flowchart of the user identity verification method in FIG. 1.

FIG. 3 is a diagram continuing the registration process of FIG. 2 with an optional step added thereto.

FIG. 4 is a schematic diagram of the user device using a smart phone as an example to display the operation interface.

FIG. 5 is a flow chart of the legitimate user accessing the distributed ledger system in FIG. 1.

### DETAILED DESCRIPTION OF THE INVENTION

Hereinafter, the steps of the user identity verification method for secure transaction environment of the present invention and the achievement of the efficacy will be described by way of examples with reference to the annexed drawings. The components, composition, and processes of the user identity verification method for the secure transaction environment in each of the drawings are only used to illustrate the technical features of the present invention and are not intended to limit the present invention.

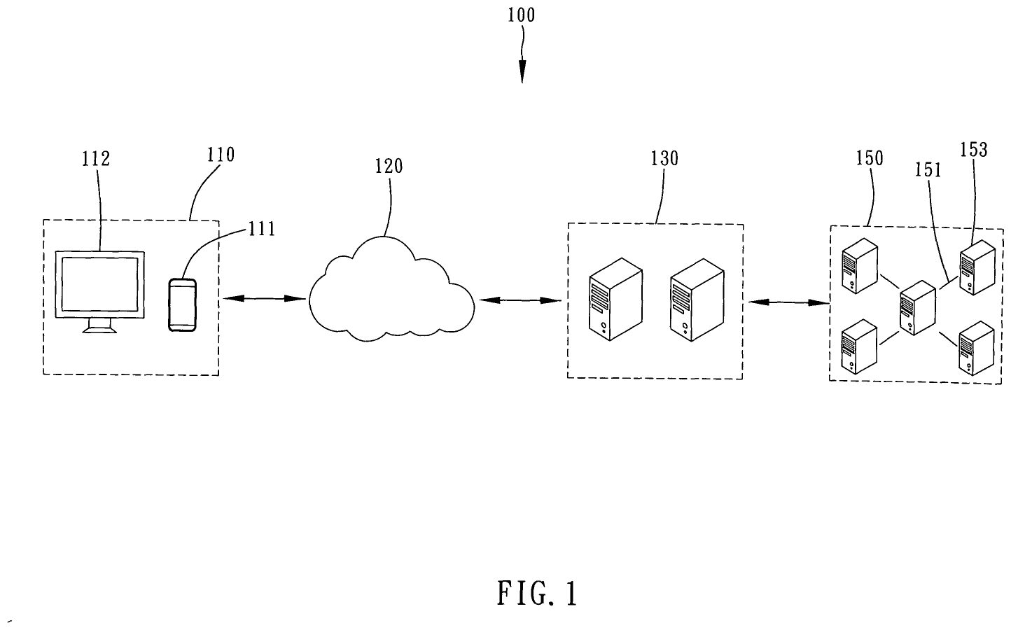

FIG. 1 is a schematic diagram of an embodiment of a secure transaction environment (system) of the present invention, the secure transaction environment (system) 100 providing a user for secure identity registration, login, and access, comprising a user device 110, a portal system 130 and a distributed ledger system 150.

The user device 110 can be a portable computing device or a stationary computing device. The portable computing device can be a smart phone 111, a smart watch, a tablet, or a notebook computer. The stationary computing device can be a desktop computer 112, or an on-board computer. The user device 110 is coupled to the portal system 130 through a communication network 120.

The communication network 120 can be a public network. Any network such as a cellular telephone network, a local area network, a global network, and the Internet can be coupled by a communication means.

The portal system 130 can be one or more servers or computing devices. The portal system 130 is coupled to the distributed ledger system 150 via an open network, a private network, or a hybrid network. The servers of the portal system 130 are coupled to each other through a network. The portal system manages the distributed ledger system. The portal system stores and executes various software or programs used for verification and trading and is used to generate one-time verification information. The one-time verification information may include numbers, text, images, photos, sounds, or any combination of information to provide users with one-time verification. The private network means that there is no open network, and no computing device can connect and access freely through the communication network.

The distributed ledger system 150 includes a plurality of blockchain servers 153 inter-linked 151 to perform blockchain technology operations. The link 151 is through a private network and can be connected by wire or wirelessly. The private network means that no one is free to access. It is managed by a specific organization, enterprise or organization. This management method is also called private chain.

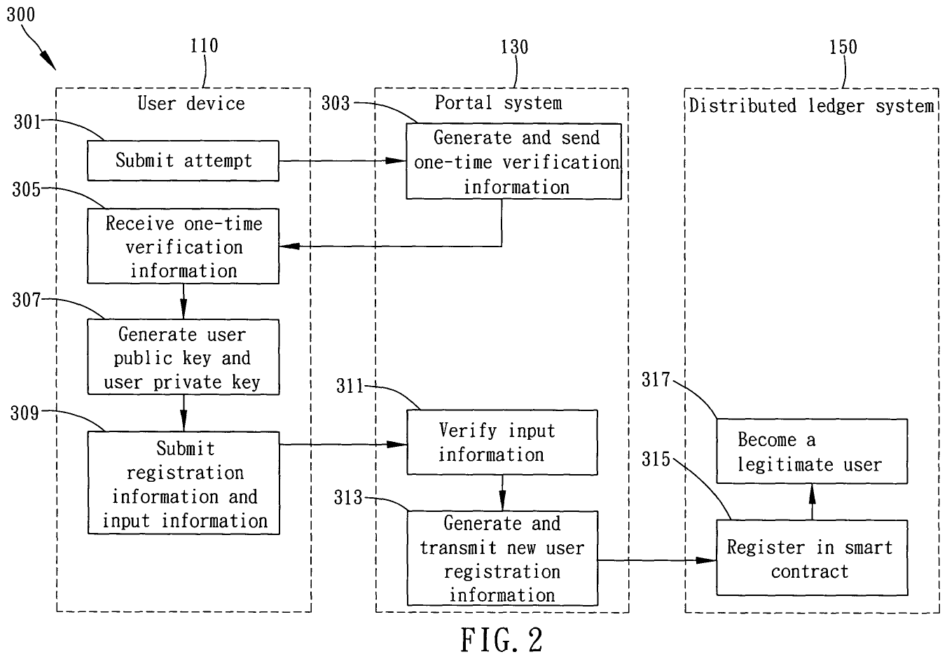

FIG. 2 is a registration flowchart of the user identity verification method in FIG. 1. The secure transaction environment allows a new user to establish a user account through the registration process 300. After the registration is completed, the new user can access the distributed ledger system managed by the portal system. In the registration process 300, the user submits an attempt to the portal system through the user communication code of the user device (step 301). The attempt includes the user communication code. Thereafter, the portal system 130 sends one-time verification information according to the user communication code (step 303). Then, the user device 110 receives the one-time verification information (step 305), and the user device 110 generates a user public key and a user private key corresponding to the user communication code (step 307). After that, the user device 110 submits registration information and input information to portal system 130 (step 309). The registration information includes the user communication code and the user public key but does not include the user private key that matches the user communication code. The input information responds to the one-time verification information. The portal system 130 verifies the input information (step 311). When the input information satisfies the one-time verification information, the portal system generates and transmits new user registration information to the distributed ledger system (step 313). The new user registration information includes the registration information. The distributed ledger system registers the registration information of the new user registration information in the smart contract of the distributed ledger system (step 315) to become a legitimate user (step 317) and allows the legitimate user to access the distributed ledger system through the user communication code. The smart contract includes the user public key that matches the user communication code. After the registration information is registered, the user communication code has become a legitimate account of the secure transaction environment. If the verification fails in step 311, steps 313-317 are not performed. The verification failure includes the input information error, or the user communication code of the registration information is different from the user communication code when the attempt is submitted.

The user communication code includes one of the user device's phone number, instant messaging account, and email address. In the phone number part, the portal system can send a one-time verification message corresponding to the newsletter or voice message to the user device through the phone number. In the instant messaging part, the portal system can provide private one-time verification information through the account corresponding to the instant messaging software such as LINE, WeChat, WhatsApp, SKYPE and FACEBOOK. In the email messaging part, the portal system provides one-time verification information via email address.

In this way, the user can establish the user communication code in the distributed ledger system through the portal system 130 according to the registration process 300 for future access. It should be noted that the user public key and the user private key are generated in the user device, and the user private key is not required in the attempt process. Therefore, the portal system and the distributed ledger system do not have the user private key of the user. Therefore, the user's private key will not be stored in the portal system or distributed ledger system, ensuring transaction security.

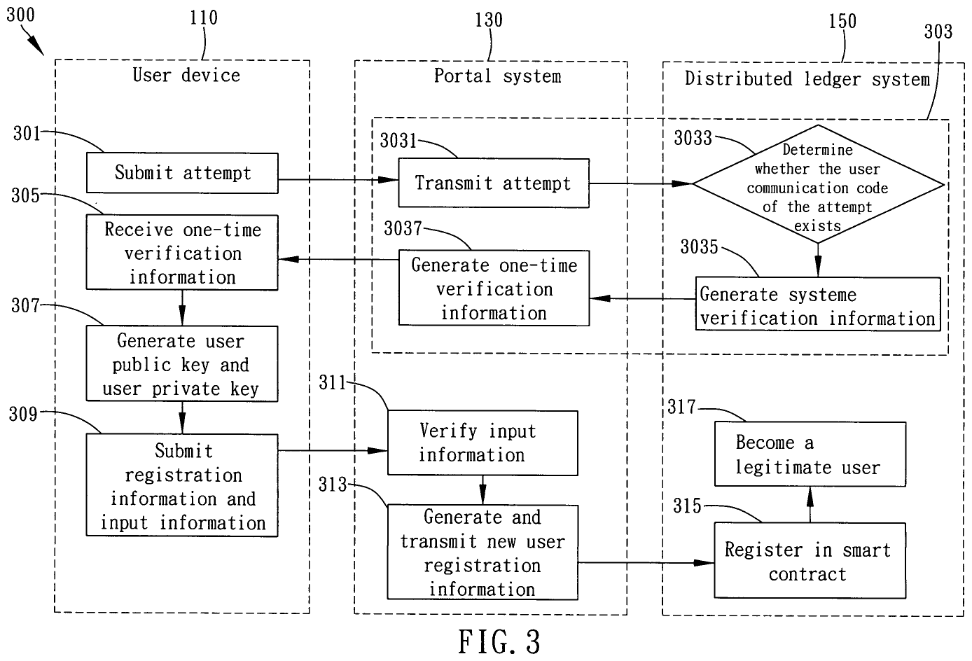

FIG. 3 is a diagram continuing the registration process of FIG. 2 with an optional step added thereto. When compared to the registration process of FIG. 2, step 303 in the registration process of FIG. 3 generates and outputs one-time verification information after mutual authentication by the portal system and the distributed ledger system to confirm the source of the single verification data, however, the one-time verification information generated and sent in FIG. 2 is done by the portal system alone.

The generation of the one-time verification information in step 303 includes: the portal system transmits the attempt to the distributed ledger system (step 3031), and then the distributed ledger system determines whether the user communication code of the attempt exists in the distributed ledger system (step 3033), and then the distributed ledger system generates system verification information when it is confirmed that there is no distributed ledger system in the user communication code (step 3035), and then the portal system receives the system verification information and generates one-time verification information according to the system verification information (step 3037). In this way, the correctness of the portal system and the distributed ledger system is verified through steps 3031-3037 to prevent the camouflage server from entering the secure transaction environment.

The generation of the new user registration information in step 313 includes encrypting the system verification information and the registration information through the system private key of the portal system.

The registration step of step 315 includes the distributed ledger system verifying that the new user registration information satisfies the system public key of the portal system, and then writing the registration information to the smart contract. When the verification of step 315 is satisfied, it indicates that the registration information and the system verification information are correct, and therefore, the registration information can be established as a smart contract. Conversely, when the verification cannot be satisfied, it means that there is a camouflage server in the portal system or distributed ledger system, and the smart contract cannot be established. As such, the security of the secure transaction environment will be improved.

The registration is that the portal system submits the transaction to the distributed ledger system with the encrypted new user registration information, and then all the nodes in the distributed ledger system perform the consensus calculation through the user communication code. After that, the node that firstly completed the calculation will record the verified transaction on all nodes to complete the establishment of the smart contract.

Satisfaction refers to the logic or condition that the input information meets, corresponds to, or responds to one-time verification information. For example, the user needs to select a photo related to a specific item, text or color, or the result of the user's mathematical operation or other logical arrangements, such as the user to enter a specific arrangement of text or numbers.

In this embodiment, the user device can execute a mobile application (APP) to operate the registration process 300, and the mobile application can generate the user public key and the user private key according to the one-time verification information. The mobile application (APP) can be built into the user device or downloaded from the website, web interface and mobile application database.

The address that the user can access through the user communication code includes the user communication code, indicating that the user displays the user communication code when accessing the portal system or the distributed ledger system, so that the user or the transaction party can identify it.

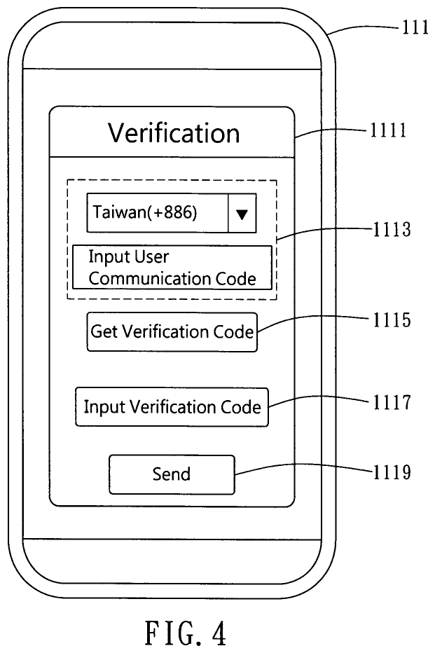

As shown in FIG. 4, the user device takes a smart phone 111 as an example. The smart phone 111 executes a mobile application (APP) and displays a corresponding operation interface 1111 on the screen for the user to input the phone number (user communication code) into the phone number input field 1113 of the operation interface 1111 and to perform step 301 through GET VERIFICATION CODE button 1115. After receiving the one-time verification information, input the input information (verification code) corresponding to the one-time verification information in the verification code input field 1117 of the verification operation interface 1111, and then press SEND button 1119, indicating that step 309 is performed. After the portal system and the distributed ledger system complete the user registration, the user can access the portal system and the distributed ledger system.

In this embodiment, the one-time verification information can be displayed elsewhere, and is not limited to the verification operation interface 1111. In other embodiments, the operation interface may be other configurations, and the interface may be switched to a plurality of configured interfaces. Therefore, the operation interface is not limited to the one depicted in FIG. 4.

In other embodiments, the registration process 300 can be performed by an operation interface, a website, or a web interface hosted by the portal system. Therefore, it is not limited to the mobile application (APP), but the user public key and the user private key are still generated through the user device.

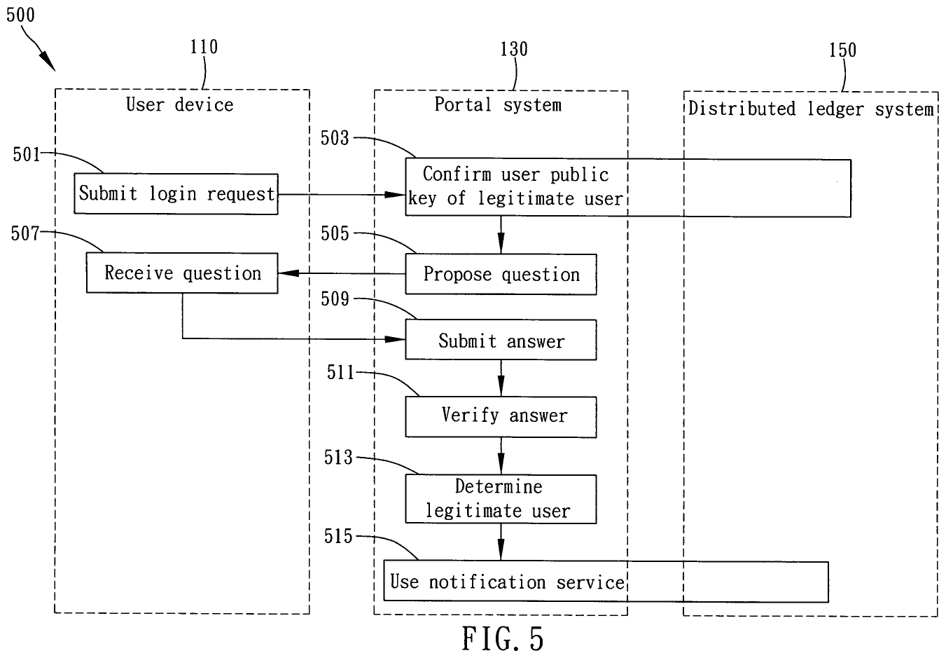

As shown in FIG. 5, the access process 500 for accessing the distributed ledger system includes the legitimate user submitting a login request to the portal system through the user communication code (step 501), then, the portal system confirms the user public key of the legitimate user through the distributed ledger (step 503) and proposes a question including the answer limit time to the legitimate user (step 505), and then the user device receives the question (step 507) and then the user device encrypts the question through the user private key to complete the answer within the answer limit time and submits the encrypted answer to the portal system (step 509), and then the portal system verifies the answer (step 511) and determines that the legitimate user is a legitimate user after confirming that the user public key of the answer meets the user public key of the legitimate user (step 513), and then the portal system allows the legitimate user to use the notification service (step 515).

In this embodiment, the confirmation mode of step 503 is that the portal system confirms by using the distributed ledger system. In other embodiments, the confirmation mode may also be a direct confirmation by the portal system to shorten the operation time. In other embodiments, step 503 can be omitted. After step 501, step 505 is directly executed, the question is proposed by the user communication code, and the user identity is verified through steps 505-509.

The answer limit time of the question in steps 505-509 is in nanoseconds. Therefore, if it is not a login request submitted by a legitimate user, it means that the user private key is not available to the legitimate user, and the login cannot answer the question within a limited answering time, so the user identity can be verified in a safer manner. In other embodiments, the answer limit time can also be shorter or longer unit time.

In step 511, verifying the answer mode is a calculation method known by the blockchain technique. However, if the answer cannot confirm the legality of the user public key, the portal system and the distributed ledger system do not allow any transaction activity. The notification service of step 515 includes various transaction activities regarding the legitimate account, and the portal system will actively notify the user through the user communication code corresponding to the legal account.

Finally, it is emphasized that the constituent elements disclosed in the foregoing embodiments are merely illustrative and are not intended to limit the scope of the present invention, and alternatives or variations of other equivalent elements should also be the scope of the claims of the present application.

What is claimed is:

1. A user identity verification method for secure transaction environment, comprising the steps of;
a user device submitting an attempt to a portal system, said attempt comprising a user communication code;
said portal system generating and transmitting a one-time verification information, said one-time verification information corresponding to said user communication code;
said user device receiving said one-time verification information and generating a user public key and a user private key;
said user device submitting a registration information and an input information, said registration information comprising said user communication code and said user public key, said input information responding to said one-time verification information; and
said portal system verifying said input information, said portal system generating and transmitting a new user registration information to a distributed ledger system when said input information satisfies said one-time verification information, said new user registration information comprising said registration information, said distributed ledger system registering said registration information in a smart contract of said distributed ledger system to become a legitimate user and allowing said legitimate user to access said distributed ledger system.

2. The user identity verification method for secure transaction environment as claimed in claim 1, wherein the generation of said one-time verification information comprises the steps of:
said portal system transmitting said attempt to said distributed ledger system;
generating a system verification information corresponding to said user communication code when said distributed ledger system confirms that said user communication code does not exist; and
said portal system receiving said system verification information and generating said one-time verification information according to said system verification information.

3. The user identity verification method for secure transaction environment as claimed in claim 2, wherein the generation of said new user registration information comprises the step of encrypting said system verification information and said registration information through a system private key of said portal system.

4. The user identity verification method for secure transaction environment as claimed in claim 3, wherein the registration of said registration information in a smart contract of said distributed ledger system comprises the step of writing said registration information into said smart contract after said distributed ledger system decrypts said new user registration information to satisfy a system public key of said portal system.

5. The user identity verification method for secure transaction environment as claimed in claim 1, wherein said user public key and said user private key are generated by said user device.

6. The user identity verification method for secure transaction environment as claimed in claim 1, wherein said access and the address of said smart contract comprise said user communication code of said user device.

7. The user identity verification method for secure transaction environment as claimed in claim 1, wherein said user communication code comprises one of a phone number, an instant messaging account and an email address of said user device.

8. The user identity verification method for secure transaction environment as claimed in claim 1, wherein said distributed ledger system comprises a plurality of blockchain servers that are linked together.

9. The user identity verification method for secure transaction environment as claimed in claim 1, wherein said access comprises the steps of:
said legitimate user sending a login request to said portal system through said user communication code;
proposing a question to said legitimate user, said question comprising an answer limit time;
said legitimate user receiving said question and encrypting said question through said user private key to complete the answer within said answer limit time and then submitting the encrypted said answer to said portal system; and
said portal system verifying said answer and determining that said legitimate user is a legitimate user after confirming that said user public key of said answer meets said user public key of said legitimate user and then allowing said legitimate user to use a notification service.

10. The user identity verification method for secure transaction environment as claimed in claim 9, wherein said question proposed to said legitimate user includes confirming said user public key for said legitimate user.
